(19) United States
(12) Patent Application Publication
(10) Pub. No.: US 2026/0094841 A1
(43) Pub. Date: Apr. 2, 2026

(54) CARBON-RICH STRUCTURES FOR SUPPRESSION OF THERMAL RUNAWAY, AND ELECTRODES AND ELECTROCHEMICAL CELLS CONTAINING THE SAME

(71) Applicant: Solid Power Operating, Inc., Louisville, CO (US)

(72) Inventors: Forrest LASKOWSKI, Bend, OR (US); Rose E. RUTHER, Lafayette, CO (US); Stephanie YOUNG, Louisville, CO (US); Derek JOHNSON, Fort Collins, CO (US); Saalik RAUF, Boulder, CO (US)

(21) Appl. No.: 19/345,692

(22) Filed: Sep. 30, 2025

Related U.S. Application Data
(60) Provisional application No. 63/701,126, filed on Sep. 30, 2024.

(51) Int. Cl. H01M 4/62; H01M 4/04; H01M 4/131; H01M 4/1391; H01M 4/36; H01M 10/052

(52) U.S. Cl. CPC H01M 4/628; H01M 4/0404; H01M 4/131; H01M 4/1391; H01M 4/366; H01M 4/621; H01M 10/052

(57) ABSTRACT

Sacrificial carbon structures for inhibiting thermal runaway in an electrochemical cell, and electrodes and electrochemical cells including the same. Structures having increased carbon content may be incorporated into the electrodes such that the carbon is positioned to react with released oxygen, to mitigate thermal runaway. These structures may take the form of a sacrificial carbon layer, a plurality of sacrificial carbon layers, and/or a multilayer active material layer having a sacrificial carbon base layer.

### CROSS-REFERENCE TO RELATED APPLICATION

This application claims the benefit of U.S. Provisional Patent Application No. 63/701,126, filed on Sep. 30, 2024, and titled “CARBON-RICH STRUCTURES FOR SUPPRESSION OF THERMAL RUNAWAY, ELECTRODES, AND ELECTROCHEMICAL CELLS CONTAINING THE SAME,” which is incorporated by reference herein in its entirety.

### BACKGROUND

Thermal runaway is a critical concern in battery systems, including both solid-state and liquid electrolyte lithium-ion batteries. Thermal runaway refers to a chain reaction where an increase in temperature leads to further increases in temperature, potentially resulting in catastrophic failure of the battery. A battery generates heat during normal operation due to electrical resistance and chemical reactions. Under normal conditions, this heat is managed by the battery's thermal management systems. However, if the battery's temperature rises beyond a certain threshold—e.g., due to overcharging, short-circuiting, or physical damage—the internal temperature can start to increase rapidly.

This issue may be especially pronounced in the positive electrode, or cathode, because oxide active materials (e.g. NMC (nickel-manganese-cobalt), LFP (lithium-iron-phosphate), LMO (lithium-manganese-oxide), etc.) are often used in the cathode. When oxide cathode active materials experience electrochemical, mechanical, and/or heat stress they may release some of the oxygen contained in their structure. This released oxygen may react with other battery components such as solid-state electrolyte materials, liquid electrolytes, or lithium containing anode materials (e.g. Li metals or Li—Si alloys).

When oxygen reacts with these other battery components, the reaction generates heat. This heat then promotes further oxygen release from the cathode active material. If heat generation from reactions exceeds the typical heat dissipation rate (e.g. via convection with the environment or cooling from a thermal management system), the result is then a positive feedback loop where heightened reactivity produces more heat, leading back to more reactivity. This self-promoting reaction may generate enough heat for these battery components to react with otherwise stable components.

If the temperature continues to rise, the battery may vent, releasing hot gases and, in severe cases, catch fire or catastrophically explode. In a larger battery pack or system, thermal runaway in one cell can spread to adjacent cells, leading to widespread failure. Thermal runaway is an ongoing safety concern, especially in applications like electric vehicles and large-scale energy storage systems.

Thermal runaway may be of particular concern in batteries containing aluminum current collectors, due to the potential for a thermite reaction to occur between the aluminum of the current collector and the reactive oxygen species generated from metal oxides present in the active material layer, when extremely high temperatures are reached.

To mitigate these risks, battery designs include various safety features such as thermal protection circuits, advanced cooling systems, and careful monitoring of temperature and charge levels. However, these systems may add considerable volume, weight, cost, and complexity to battery systems.

Accordingly, for these and a host of other reasons, there is a need for solutions which reduce the risk of thermal runaway, and in particular the risk for highly exothermic reactions between the oxygen present in active materials and the metal of the current collector. Preferably, such solutions might complement or replace some or all existing system, and do so without adding significant, volume, mass, complexity, and/or cost to the battery system as a whole.

It is with these observations in mind, among others, that aspects of the present disclosure were conceived.

### BRIEF SUMMARY

Disclosed are carbon-rich structures for inhibiting thermal runaway in an electrochemical cell, and electrodes and electrochemical cells including the same. Structures having increased carbon content may be incorporated into the electrode such that the carbon is positioned to react with oxygen released from active materials, to mitigate thermal runaway. The disclosed structures may be incorporated in an electrode to provide the electrode with a high carbon content, without the need to mix elevated carbon amounts into an electrode slurry. Therefore, the disclosed electrodes may not contain uniformly elevated carbon contents throughout the active material layer. These disclosed structures may take the form of a sacrificial carbon layer, a plurality of sacrificial carbon layers, and/or a multilayer active material layer having a carbon-rich base layer or region positioned near the current collector.

According to some aspects, an electrode for an electrochemical device includes a current collector and an active material layer composed of an active material, a first binder, and a conductive material. A sacrificial carbon layer, which consists of a carbon-based material and a second binder, may be positioned between the current collector and the active material layer. The sacrificial carbon layer may have a thickness of at least 10 μm. The active material layer may have a carbon content of no more than 7 weight percent, while the carbon content of the sacrificial carbon layer is greater than that of the active material layer.

The carbon-based material in the sacrificial carbon layer can be selected from carbon black, graphite, carbon fiber, amorphous carbon, graphene, or carbon nanotube, and in some embodiments, it is carbon black. The first binder and the second binder may be the same, and in some embodiments, the second binder is polyacrylic acid. The sacrificial carbon layer may have a thickness of at least 15 μm, no more than 30 μm, or no more than 20 μm. The loading amount of the sacrificial carbon layer may be within the range of 1 mg to 5 mg per cm² of the current collector, with specific embodiments ranging from 2 mg to 4 mg, or 2 mg to 3 mg per cm².

The oxide active material in the active material layer may have a molar ratio of carbon to oxygen within a range of 1:3 to 2:1, or in some embodiments, from 1:2 to 1:1. The electrode may be a cathode, and the active material in such a cathode may be a NMC-type active material.

An electrochemical cell may include the above electrode, a separator, and a second electrode.

According to some aspects, a method for manufacturing the electrode includes providing the current collector, forming the sacrificial carbon layer, preparing a slurry with the active material, the first binder, the conductive material, and a solvent, casting this slurry on the sacrificial carbon layer to form a slurry-coated layer, drying the slurry to produce a dried slurry-coated layer, and densifying the dried slurry-coated layer to create the active material layer. Methods for forming the sacrificial carbon layer can include atomic layer deposition, chemical vapor deposition, electrodeposition, slurry coating, spraying, or dry processing. The sacrificial carbon layer may be formed directly on the surface of the current collector or on a primer layer coated onto the current collector.

Another embodiment of an electrode includes a current collector, a first electrode active material layer disposed on a surface of the current collector, and a second electrode active material layer on top of the first layer, where the first layer has a higher carbon content than the second.

A further embodiment includes an electrode with an aluminum current collector and an electrode active material layer composed of electrode active material, binder, and carbon-based material, disposed on the current collector, where the concentration of the carbon-based material decreases from the side contacting the current collector to the opposite side of the active material layer.

### BRIEF DESCRIPTION OF THE DRAWINGS

FIG. 1 illustrates an electrochemical cell including a sacrificial carbon layer in accordance with one embodiment.

FIG. 2 illustrates an electrochemical cell including a plurality of carbon-rich sacrificial carbon layers in accordance with one embodiment.

FIG. 3 illustrates a coating method of a multilayer electrode in accordance with one embodiment.

FIG. 4 illustrates a coating method and the resulting structure of a multilayer electrode in accordance with one embodiment.

### TERMS AND DEFINITIONS

As used in the specification and the appended claims, the singular forms “a,” “an,” “the” and the like include plural referents unless the context clearly dictates otherwise. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, “active material” refers to a material within an electrode that participates in electrochemical reactions and is responsible for the storage and release of electrical energy in an electrochemical cell. “Active material layer” refers to a layer within an electrode that contains the active material, a conductive material, and a binder. Active material layers may typically be slurry coated onto a current collector.

As used herein, “binder” refers to a material used to hold together the active materials, conductive agents, and other components within an electrode, providing mechanical integrity and adhesion to the current collector in an electrochemical cell. As used herein, “current collector” refers to a conductive substrate, typically made of metal foil such as copper or aluminum, that provides electrical connectivity between the active material of an electrode and the external circuit in an electrochemical cell. The current collector facilitates the efficient flow of electrons to and from the electrode during charge and discharge cycles.

As used herein, “sacrificial carbon” refers to a carbon-containing material intentionally incorporated into an electrode or electrochemical cell structure, which is designed to react with and consume released oxygen in the event of thermal runaway, thereby mitigating or inhibiting further exothermic reactions within the cell.

As used herein, “sacrificial carbon layer” refers to structure or layer refers to a structure, layer, or region which contains sufficient elemental carbon as to stoichiometrically react with at least 10% of the elemental oxygen contained in the active material present in an electrode. According to the present disclosure, the sacrificial carbon layer may be distinct from, and used in addition to, a conventional primer layer disposed on the current collector and the active material layer. According to some aspects, the sacrificial carbon layer may have an increased thickness or carbon loading amount in relation to a conventional primer layer and may have an increased concentration of carbon, in relation to the active material layer.

As used herein, “thickness” refers to a dimension extending perpendicular to the longest dimension current collector (unless otherwise defined).

### DETAILED DESCRIPTION

The present disclosure provides sacrificial carbon structures for inhibiting thermal runaway in an electrochemical cell, and electrodes and electrochemical cells including the same. Regions and structures having increased carbon content may be incorporated into the electrode such that the carbon is positioned to react with oxygen released from an active material, to mitigate thermal runaway. Accordingly, the present disclosure provides electrodes, electrochemical cells, and methods of producing and using the same, which include a sacrificial carbon layer disposed between the current collector and the active material layer. The sacrificial carbon layer may have a higher carbon content (i.e., carbon concentration or density) than the active material layer.

Cathode active materials, in particular, tend to include oxides. If enough carbon is close to the cathode active material when it releases oxygen at an elevated temperature, the oxygen may react with the carbon to form carbon dioxide (CO₂) and/or carbon monoxide (CO). The partial combustion reaction to form CO is often endothermic, removing heat from the cell and interrupting or possibly even halting the feedback cycle needed to cause thermal runaway. The full combustion reaction to form CO₂ is often slightly exothermic, but much less so than the formation of other oxides, thus mitigating and preventing the escalation of heat and reactivity caused by oxygen's reaction with metals (e.g., of the current collector) or electrolyte. Depending on the system, both gas evolution reactions may occur-producing an outcome that is very low in heat output or even endothermic.

An electrode of the present disclosure may contain a current collector and an active material layer disposed on at least one side of the current collector. The active material layer may contain an active material, a conductive material, and a binder. According to some aspects, the active material layer of the disclosed electrodes may not have an elevated carbon content, i.e., the active material layer may have a carbon content of no more than 7 wt %, no more than 5 wt %, no more than 4 wt %, no more than 3.5 wt %, or no more than 3 wt %, based on a total weight of the active material layer. The current collector may be in the form of a metal foil, mesh, sheet, or web formed of one or more of copper (Cu), nickel (Ni), steel, aluminum (Al), graphite, and titanium (Ti). Aluminum may be a preferred material for the current collector due to its high conductivity and relatively low cost. While aluminum may typically be less desirable due to the thermite reaction that can occur if thermal runaway progresses, the disclosed electrodes incorporating the sacrificial carbon layer may be able to use an aluminum current collector with increased safety in comparison to conventional systems.

In the case that the electrode is a cathode (positive electrode), the active material may include one or more of NMC (nickel-manganese-cobalt), LFP (lithium-iron-phosphate), NCA (lithium-nickel-cobalt-aluminum-oxide, LMO (lithium-manganese-oxide), LNO (lithium-nickel-oxide), or LVO (lithium-vanadium-oxide). In some embodiments, the cathode active material may comprise, e.g., Li(NiₐCo_{b}Mn_{c})O₂ (0<a<1, 0<b<1, 0<c<1, a+b+c=1), NMC 111 (LiNi_{0.33}Mn_{0.33}Co_{0.33}O₂), NMC 433 (LiNi_{0.4}Mn_{0.3}Co_{0.3}O₂), NMC 532 (LiNi_{0.3}Mn_{0.3}Co_{0.2}O₂), NMC 622 (LiNi_{0.6}Mn_{0.2}Co_{0.2}O₂), NMC 811 (LiNi_{0.8}Mn_{0.1}Co_{0.1}O₂), or a combination thereof. In some aspects, the cathode active material may comprise one or more of a coated or uncoated metal oxide, such as but not limited to V₂O₅, V₆O₁₃, MoO₃, LiCoO₂, LiNiO₂, LiMnO₂, LiMn₂O₄, LiNi_{1-Y}Co_{Y}O₂, LiCo_{1-Y}Mn_{Y}O₂, LiNi_{1-Y}Mn_{Y}O₂ (0≤Y<1), Li(NiₐCo_{b}Mn_{c})O₄ (0<a<2, 0<b<2, 0<c<2, a+b+c=2), LiMn_{2-Z}Ni_{Z}O₄, LiMn_{2-Z}Co_{Z}O₄ (0<Z<2), LiCoPO₄, LiFePO₄, CuO, or Li(NiₐCo_{b}Al_{c})O₂ (0<a<1, 0<b<1, 0<c<1, a+b+c=1). In the case that the electrode is an anode (negative electrode), the active material may include one or more of lithium metal, silicon, or a Li—Si alloy.

The binder may include one or more of a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVDF), polyhexafluoropropylene (PHFP), and polytetrafluoroethylene (PTFE), and binary copolymers such as copolymers of VdF and HFP such as poly(vinylene difluoride-hexafluoropropylene) copolymer (PVDF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may be one or more of an acrylic resin such as but not limited to polymethyl (meth) acrylate.

The conductive material may include one or more of carbon black, graphite, carbon fibers, amorphous carbon, graphene, carbon nanotubes, and the like.

The electrodes of the present disclosure may be made by slurry coating methods in which the active material, binder, and conductive material are mixed with a solvent to form a slurry, the slurry is coated on a surface of the current collector, the coated slurry is dried, and the dried slurry is rolled, pressed, or otherwise densified.

As thermal runaway may be initiated and propagated by reactive oxygen generated by heating of oxide active materials, it is ideal to position carbon sources near the active material to react with the generated oxygen. While conventional batteries often contain a carbon-based conductive material within the active material layer, the amount of carbon provided by the conductive material is not sufficient to neutralize the reactive oxygen generated, as demonstrated by the continued existence of the thermal runaway problem in conventional batteries (which typically contain a conductive material). Accordingly, to mitigate thermal runaway, aspects of the present disclosure involve including additional carbon sources in proximity to the active material.

One way to accomplish incorporating the required amount of carbon into the active material layer is to add more carbon material to the slurry prior to forming the active material layer. Unfortunately, these carbon materials generally have high surface areas and are not easily dispersed. When a large amount of carbon is added to the slurry, the large surface area of the carbon may affect the slurry rheology to the point of inoperability. Large carbon concentrations in the slurry may also negatively impact ionic transference processes that are required for a high-performance electrode. Accordingly, it is often not feasible to reach the required level of carbon content by including the full amount in the slurry for coating.

Disclosed are structures providing high carbon content, which do not require mixing elevated carbon amounts into an electrode slurry and do not contain uniformly elevated carbon contents throughout the active material layer, (i.e., carbon contents of more than 7 wt %, more than 5 wt %, more than 4 wt %, more than 3.5 wt %, or more than 3 wt %, based on a total weight of the active material layer, are not uniformly present throughout the layer(s) disposed on the current collector). These structures may take the form of a layer, which may be an additional layer as compared to conventional cell structures, referred to herein as a “sacrificial carbon layer,” a plurality of sacrificial carbon layers, and/or a multilayer active material layer having a sacrificial carbon base layer.

### Sacrificial Carbon Layer

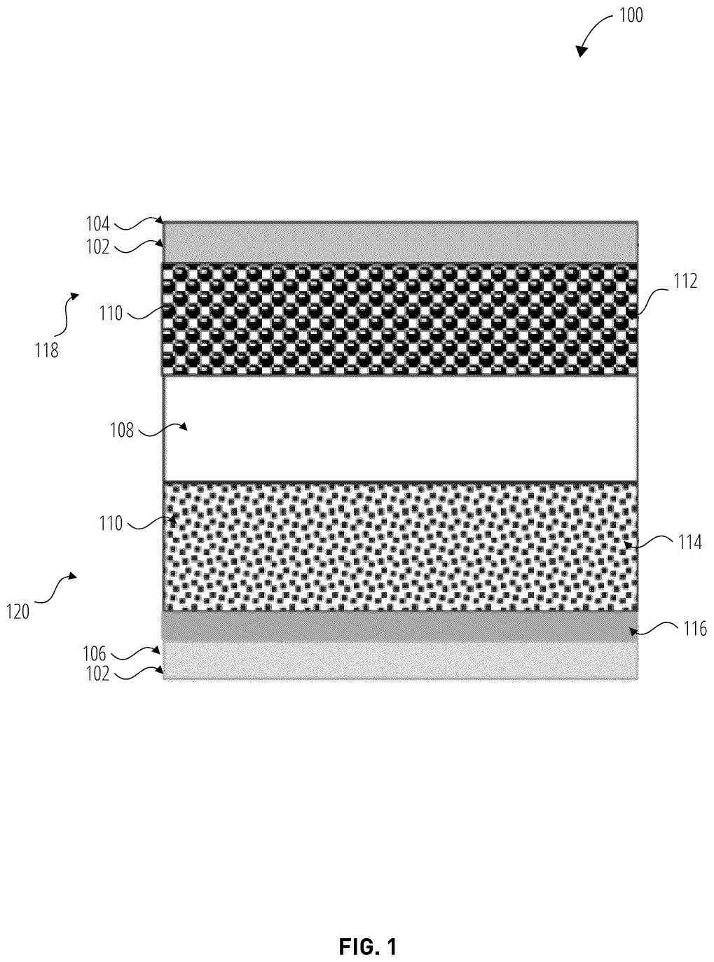

Rather than including additional carbon throughout the active material layer, carbon may be added adjacent the current collector in the form of a sacrificial carbon layer, as shown in FIG. 1. FIG. 1 depicts an electrochemical cell 100, including an anode 118, a cathode 120, and a separator 108. Each of the electrodes may include a current collector 102 and an active material layer 110. Accordingly, the anode 118 may include an anode current collector 104 and an anode active material layer 112. Similarly, the cathode 120 may include a cathode current collector 106 and a cathode active material layer 114.

In some embodiments, as shown in FIG. 1, the cathode 120 may include a sacrificial carbon layer 116, disposed between the cathode current collector 106 and the cathode active material layer 114. According to some embodiments, the sacrificial carbon layer 116 may be disposed directly in contact with the current collector 102, while in other embodiments, a primer layer may be interposed between the sacrificial carbon layer 116 and the cathode active material layer 114. Additionally, in some embodiments, the anode 118 may include a sacrificial carbon layer in addition to or instead of the cathode 120. As in the cathode 120, the sacrificial carbon layer 116 may be disposed directly on the current collector 102, or there may be a primer layer interposed between the two.

Conventionally, a primer layer on a current collector—such as aluminum for cathodes or copper for anodes—serves to promote adhesion between the bare metal and the subsequent electrode coating. This layer is usually a thin film (approximately 0.05 μm to 0.5 μm) composed of polymers like polyvinylidene fluoride (PVDF), polyimide, or other adhesion-promoting agents. It may be applied by techniques such as slot-die coating, spray-coating, or dip-coating, followed by drying or curing. In some cases, the primer is formulated with functional additives (e.g., conductive carbon, coupling agents) to enhance surface conductivity or chemical compatibility. Accordingly, in some cases, a conventional primer layer may include some carbon. However, because conventional primer layers are typically thinner with lower carbon content than the disclosed sacrificial carbon layer, they do not contain sufficient carbon content to significantly mitigate thermal runaway risk.

According to some aspects, the sacrificial carbon layer 116 may be formed by using atomic layer deposition (ALD), chemical vapor deposition (CVD), electrodeposition, slurry coating, spraying, dry processing, or other methods known in the art. For instance, the sacrificial carbon layer 116 may also be formed via pyrolysis of an organic starting material, e.g., the current collector could be coated by a thin layer of organic fluid such as acetone, followed by heat treatment.

Constructing the sacrificial carbon layer with a specific composition, density, and thickness can ensure that there is sufficient carbon proximate to the active material. The sacrificial carbon layer may comprise a carbon-based material and a binder. In some embodiments, the carbon-based material may include one or more of carbon black, graphite, carbon fibers, amorphous carbon, graphene, carbon nanotubes, and the like. In some embodiments, the binder may include one or more of a fluororesin containing vinylidene fluoride (VdF), hexafluoropropylene (HFP), tetrafluoroethylene (TFE), and derivatives thereof as structural units. Specific examples thereof include homopolymers such as polyvinylidene fluoride (PVDF), polyhexafluoropropylene (PHFP), and polytetrafluoroethylene (PTFE), and binary copolymers such as copolymers of VdF and HFP such as poly(vinylene difluoride-hexafluoropropylene) copolymer (PVDF-HFP), and the like. In another embodiment, the binder may be one or more of a thermoplastic elastomer such as but not limited to styrene-butadiene rubber (SBR), styrene-butadiene-styrene copolymer (SBS), styrene-isoprene block copolymer (SIS), styrene-ethylene-butylene-styrene (SEBS), polyacrylonitrile (PAN), nitrile-butylene rubber (NBR), polybutadiene, polyisoprene, Poly (methacrylate) nitrile-butadiene rubber (PMMA-NBR) and the like. In a further embodiment, the binder may be one or more of an acrylic resin such as but not limited to polymethyl (meth) acrylate. In some embodiments, the binder of the sacrificial carbon layer and the binder of the active material layer may be different, while in some embodiments, they may be the same species or mixture.

In some embodiments, the sacrificial carbon layer may contain carbon in an amount of at least 50 wt %, more preferably at least 70 wt %, or most preferably at least 80 wt %, with respect to a total weight of the sacrificial carbon layer. In particularly preferred embodiments, the sacrificial carbon layer may contain carbon in an amount of at least 90, 95, or 98 wt %, with respect to a total weight of the sacrificial carbon layer. In contrast, the active material layer may have a carbon content of no more than 7 wt %, no more than 5 wt %, no more than 4 wt %, no more than 3.5 wt %, or no more than 3 wt %, based on a total weight of the active material layer.

The thickness of the sacrificial carbon layer may be determined by factors such as the density of the sacrificial carbon layer, the amount of oxide in the cathode, and the binder content of the sacrificial carbon layer. If the sacrificial carbon layer is very dense and the amount of oxide cathode materials used is low, then the sacrificial carbon layer may be relatively thinner. Conversely, if the density of the sacrificial carbon layer is low and the amount of oxide cathode material used is high, the sacrificial carbon layer may need to be relatively thicker. A secondary consideration is that the kinetics of reactivity between carbon and released oxygen may be influenced by the primer density. A denser carbon-based sacrificial carbon layer may result in more sluggish kinetics of reactivity with released oxygen. The ideal density is therefor system dependent, where the kinetics must be balanced with the kinetics of the alternative reactions to form oxides.

According to some aspects, the sacrificial carbon layer may have a thickness of at least 5 μm, at least 10 μm, at least 15 μm, at least 17 μm, at least 20 μm, at least 25 μm, and no more than 50 μm, no more than 40 μm, no more than 30 μm, no more than 25 μm, or no more than 20 μm. The sacrificial carbon layer may be provided in an amount of at least 0.1 mg, at least 0.5 mg, at least 1.0 mg, at least 1.5 mg, or at least 2 mg, and no more than 10 mg, no more than 5 mg, no more than 4 mg, or no more than 3 mg, per cm² of the current collector.

In some aspects, the thickness, density, and carbon content of the sacrificial carbon layer should be chosen to provide a molar ratio of carbon to oxygen in the oxide active material of at least 1:3, preferably at least 1:2. In some embodiments, the carbon:oxygen active material ratio may be no more than 2:1, preferably 1:1.

In some embodiments, the sacrificial carbon layer may be provided in the cathode, to position the excess carbon in close proximity to the oxide active materials common in cathodes. In some embodiments, the sacrificial carbon layer may additionally or alternatively be provided in the anode, so as to scavenge oxygen which may react with the anode active materials and/or the anode current collector.

### Plurality of Sacrificial Carbon Layers

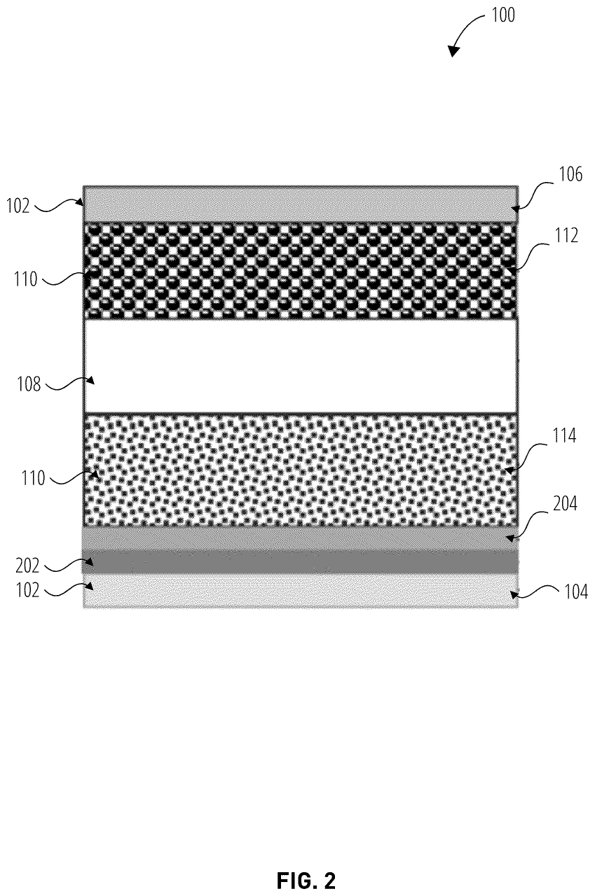

In some embodiments, multiple sacrificial carbon layers 116 may be provided adjacent the current collector 102, as shown in FIG. 2. For example, at least 2, at least 3, or at least four sacrificial carbon layers may be included and no more than 6, no more than 5, no more than 4, or no more than 3 sacrificial carbon layers may be included. In such embodiments, the active material layer may not include elevated carbon levels, i.e., the active material layer may have a carbon content of no more than 7 wt %, no more than 5 wt %, no more than 4 wt %, no more than 3.5 wt %, or no more than 3 wt %, based on a total weight of the active material layer.

As shown in FIG. 2, a first sacrificial carbon layer 202 may be provided on a surface of the current collector 102, and a second sacrificial carbon layer 204 may be provided on a surface of the first sacrificial carbon layer 202. As described above, in some instances, there may be an intervening layer, such as a primer layer, between the current collector 102 and the first sacrificial carbon layer 202. Additionally, as disclosed above, the sacrificial carbon layers disclosed herein may be applicable to either the cathode 120, the anode 118, or both.

For applications where volumetric energy density is important, reactivity of released oxygen with the carbon must be balanced with the thickness of the sacrificial carbon layer. To accomplish this, multiple sacrificial carbon layers may be used. For example, the first sacrificial carbon layer may be very dense while the second sacrificial carbon layer may have relatively lower density as compared to the first sacrificial carbon layer. The low-density sacrificial carbon layer may have more surface area available to react with reactive oxygen. This may increase the rate at which oxygen is consumed by the formation of CO₂ and/or CO. In some embodiments, the second sacrificial carbon layer may also have a higher thickness than the first sacrificial carbon layer.

These sacrificial carbon layers may also be formulated such that they have the same density, but different binders. In some embodiments, the binders may be selected such that the binder in the second sacrificial carbon layer 204 has a lower melting point than the binder in the first sacrificial carbon layer 202. When an area of the electrochemical cell starts to heat up (e.g., due to shorting, high charge/discharge rates, exothermic side reactions, externally imposed abuse conditions, etc.) the localized heating may be enough to melt the binder in the second sacrificial carbon layer 204 (which has the lower melting point). As the binder melts, it may move or flow allowing for the carbon in that sacrificial carbon layer to expose more of its surfaces. Increasing the amount of exposed carbon surfaces at the interface between the sacrificial carbon layer and the cathode should increase the rate of CO and/or CO₂ formation. The other sacrificial carbon layer(s), having binders with higher melting temperatures, may maintain the structural integrity of the surrounding material, preventing further shorting. The other sacrificial carbon layer(s), having binders with higher melting temperatures, may also serve a physical barrier blocking the reaction of released oxygen with the current collector.

In some aspects, the thicknesses, densities, and carbon contents of the plurality of sacrificial carbon layers may be chosen to provide a molar ratio of carbon to oxygen in the oxide active material of at least 1:1, preferably at least 1.5:1, and more preferably at least 2:1. In some embodiments, the carbon:oxygen active material ratio may be no more than 5:1, preferably 3:1, or more preferably 2.5:1.

In some embodiments, the sacrificial carbon layers may be provided in the cathode, to position the excess carbon in close proximity to the oxide active materials common in cathodes. In some embodiments, the sacrificial carbon layers may additionally or alternatively be provided in the anode, so as to scavenge oxygen which may react with the anode active materials and/or the anode current collector.

Multilayer Electrode with Sacrificial Carbon Base Layer

As previously discussed, addition of excess carbon may negatively affect the electrode slurry formation process, by being both extremely difficult to disperse and also by increasing viscosity of the slurry to the point where processing is impracticable or impossible. It may be possible to construct a bilayer cathode where the one cathode layer has a very high carbon content and is in contact with a carbon coated current collector. A second cathode layer can then be placed on top of the first cathode layer. Though this can be done, it undesirably adds processing time, extra drying steps, and may lead to layer delamination between the two cathode layers.

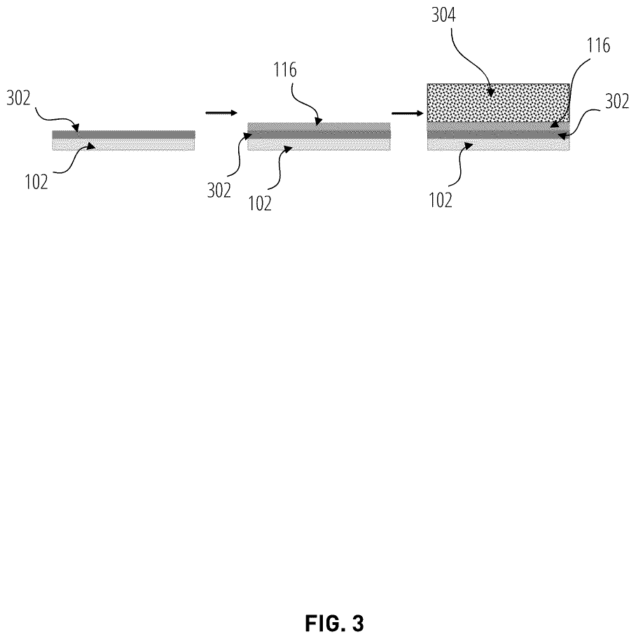

Accordingly, the present disclosure provides a method to produce a multilayer cathode without the need to coat multiple separate cathode layers with different carbon contents. As depicted in FIG. 3, the disclosed method comprises: providing a carbon-coated current collector (i.e., a current collector 102 including a carbon primer layer 302), coating a sacrificial carbon layer 116 onto the carbon-coated current collector 102, coating an active material slurry 304 onto the sacrificial carbon layer 116, drying the coated layers, and roll-pressing the dried layers to form an electrode. In some embodiments, the coating of the sacrificial carbon layer 116 may be carried out using atomic layer deposition (ALD), chemical vapor deposition (CVD), electrodeposition, slurry coating, or other methods known in the art.

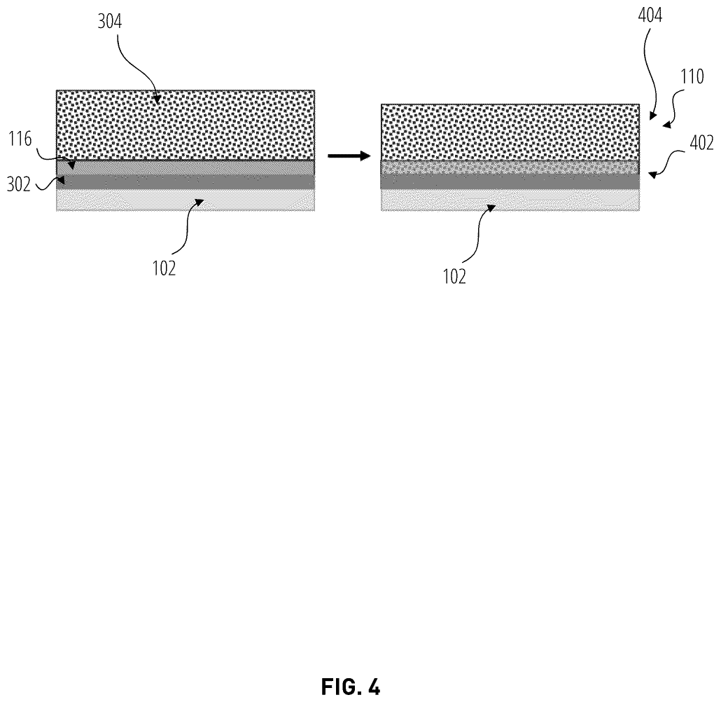

In the disclosed process, the solvent used in the electrode slurry may be selected to be able to dissolve the binder used in the sacrificial carbon layer 116. As the electrode slurry is coated onto the coated sacrificial carbon layer 116, the solvent in the slurry may redissolve the binder in the coated sacrificial carbon layer 116. As shown in FIG. 4, this may allow for the carbon in the sacrificial carbon layer 116 to shift and for the components of the slurry to settle into the coated sacrificial carbon layer 116. When the solvent dries, the binder re-solidifies, locking everything into place. In alternative embodiments, i.e., if no mixing of the sacrificial carbon layer and the active material layer is desired, the active material slurry may include a solvent which is not easily able to dissolve the binder of the sacrificial carbon layer.

Accordingly, the disclosed process may form a multilayer active material layer where the bottom section of the active material layer that sinks into the coated sacrificial carbon layer 116 effectively contains more carbon than the top section of the active material layer that did not sink into the sacrificial carbon layer 116. Thus, the disclosed multilayer active material layer may include a sacrificial carbon base layer 402 contacting the current collector 102 on one side, and a lower carbon active material layer 404 contacting the opposite side of the sacrificial carbon base layer 402. In some embodiments, one or more additional active material layers may be coated on top of the bilayer to form a multilayer active material having, e.g., at least two, at least three, at least four, or at least five layers, and no more than six, no more than five, no more than four, or no more than three layers.

According to some aspects, the lower carbon active material layer 404 may have a carbon content of no more than 7 wt %, no more than 5 wt %, no more than 4 wt %, no more than 3.5 wt %, or no more than 3 wt %, based on a total weight of the active material layer. The sacrificial carbon base layer 402 may have a carbon content that is greater than that of the lower carbon active material layer 404.

In some aspects, the thicknesses, densities, and carbon contents of the plurality of sacrificial carbon layers should be chosen to provide a molar ratio of carbon to oxide active material of at least 1:1, preferably at least 1.5:1, and more preferably at least 2:1. In some embodiments, the carbon:oxide active material ratio may be no more than 5:1, preferably 3:1, or more preferably 2.5:1.

In addition to the electrodes disclosed above, the present disclosure also provides an electrochemical cell comprising a first electrode containing enhanced carbon content and structures, as disclosed herein. The electrochemical cell may additionally comprise a second electrode (i.e. an anode, if the first electrode is a cathode; or a cathode, if the first electrode is an anode). The second electrode may contain one or more of the disclosed sacrificial carbon structures, or it may be a conventional electrode. The electrochemical cell also may contain an electrolyte and a separator. These features may take the form of a solid electrolyte or may be in the form of a liquid electrolyte with a membrane separator.

### EXAMPLES

The following examples are provided to illustrate embodiments of the invention and are not intended to limit the scope thereof.

### Example

An aluminum current collector having a foil thickness of approximately 13.5 μm was provided. The current collector had a sacrificial carbon layer made up of carbon black as a carbon material and polylacrylic acid as a binder, with a thickness of approximately 17.3 μm and a mass loading of approximately 2.05 mg/cm².

### Forming the Cathode Layer

A mixture of 622 NMC cathode active material, a SEBS binder, a carbon material in the form of carbon black, and a Li₆PS₅Cl solid electrolyte material was combined to form a cathode composite with the mass ratios between the materials being approximately 80:1.5:3:15.5. These materials were combined with an aromatic solvent and an ester solvent to form a slurry. The slurry was cast on the current collector, coated with the sacrificial carbon layer described above. The solvent was removed from the coated slurry by heating to a temperature of around 80° C. to form a dried cathode composite. This dried cathode composite was then densified to form the cathode layer.

### Forming the Separator Layer

A Li₆PS₅Cl solid electrolyte material was combined with a SEBS binder to form a separator composite with the mass ratios between the materials being approximately 90:10. These materials were combined with isobutyl isobutyrate as an ester solvent, to form a separator slurry. The separator slurry was cast on a carrier foil made of aluminum. The solvent was removed from the coated separator slurry by heating to a temperature of around 80° C. to form a dried separator composite. This dried separator composite was then densified to form the separator layer.

### Forming the Anode Layer

A mixture of silicon metal anode active material, a SEBS binder, a carbon material in the form of carbon black, and a Li₆PS₅Cl solid electrolyte material was combined to form an anode composite with the mass ratios between the materials being approximately 50:5:5:40. These materials were combined with an aromatic solvent and an ester solvent to form the anode slurry. The anode slurry was cast on a carbon coated current collector made of copper. The solvent was removed from the coated slurry by heating to a temperature of around 80° C. to form a dried anode composite. This dried anode composite was then densified to form the anode layer.

### Forming the Electrochemical Cell

A section was cut from each of the cathode layer, the separator layer, and the anode layer. The face of the anode layer and the face of the separator layer were brought together to form a stack assembled of the current collector/anode/separator/carrier foil. Pressure was then applied to this stack such that the separator laminated to the anode. The carrier foil on the separator layer was removed leaving an assembly of current collector/anode/separator. This assembly and the cathode layer were then brought into contact to form a stack with the configuration current collector/anode/separator/cathode/current collector. This stack was then compressed to form an electrochemical cell.

### Comparative Example

An aluminum current collector having a foil thickness of approximately 13.5 μm was provided. The current collector had a carbon coating (i.e., a primer layer) composed of carbon black and polyacrylic acid, with a thickness of approximately 0.5 μm and a mass loading of approximately 0.06 mg/cm².

The electrochemical cell and its components—cathode layer, separator layer, and anode layer—were all produced in the same manner as the Example, expect the aforementioned carbon coated current collector (i.e., without a sacrificial carbon layer) was used in the cathode layer.

### Results

TABLE 1

| | Discharge Resistance | Charge Resistance | |
|---|---|---|---|
| | (Ohm-cm²) | (Ohm-cm²) | FCE (%) |
| Example | 114 | 87 | 87.8 |
| Comparative | 118 | 96 | 87.5 |
| Example | | | |

For each of the electrochemical cells of the Example and Comparative Example, discharge resistance and charge resistance was measured by taking a 30 second DCIR pulse at 1 C and at 50% State of Charge (SOC).

As shown in Table 1, the electrochemical cell of the Example had a lower discharge resistance and charge resistance and similar discharge resistance first cycle efficiency (FCE) in comparison the Comparative Example. This suggests that the additional carbon on the cathode current collector provided by the sacrificial carbon layer may provide increased electrochemical performance when incorporated into an electrochemical cell.

TABLE 2

| | Current | Current | |
|---|---|---|---|
| | Collector Carbon | Collector Carbon | Energy |
| | Loading - Thickness | Loading - Mass Loading | released |
| | (um) | (mg/cm²) | (kJ/Ah) |
| Example 1 | 17.3 | 2.05 | 23 |
| Example 2 | 0.5 | 0.06 | 37 |

The electrochemical cells of the Example and Comparative Example were charged to 100% State of Charge (SOC) and then placed in a bomb calorimeter for thermal testing.

As shown in Table 2, the electrochemical cell of the Example was constructed using a sacrificial carbon layer coated on the current collector, which had a thickness of 17.3 μm and had a mass loading of 2.05 mg/cm². The energy released during the thermal runaway of the cell in the Example was around 23 KJ/Ah. The electrochemical cell of the Comparative Example was constructed using a current collector with a standard primer layer (and lacking a sacrificial carbon layer) on the cathode where the carbon primer layer had a thickness of 0.5 μm and had a mass loading of 0.06 mg/cm². The energy released during the thermal runaway of the cell in the Comparative Example was around 37 KJ/Ah. Comparing the two energy released figures, the Example had an energy release approximately 38% lower than that of the Comparative Example, demonstrating that the addition of the sacrificial carbon layer significantly mitigates thermal runaway problems.

As described herein, the devices, systems, and methods can provide several significant advantages and benefits over other devices, systems, and methods currently available in the art. However, the recited advantages are not meant to be limiting in any way, as one skilled in the art will appreciate that other advantages may also be realized upon practicing the present disclosure. It will be appreciated, moreover, that other applications for the disclosed devices, systems, and methods are also possible and considered to fall within the scope of the present disclosure.

Furthermore, those skilled in the relevant art will recognize that changes can be made to the described embodiments while still obtaining the beneficial results. It will also be apparent that some of the advantages and benefits of the described embodiments can be obtained by selecting some of the features of the embodiments without utilizing other features, and that features from one embodiment may be combined with features from other embodiments in any appropriate combination. For example, any individual or collective features of method embodiments may be applied to apparatus, product or system embodiments, and vice versa. Accordingly, those who work in the art will recognize that many modifications and adaptations to the embodiments described are possible and may even be desirable in certain circumstances, and are a part of the disclosure. Thus, the present disclosure is provided as an illustration of the principles of the embodiments and not in limitation thereof, since the scope of the invention is to be defined by the claims.

What is claimed is:

1. An electrode for an electrochemical device, comprising:
a current collector;
an active material layer comprising an active material, a first binder, and a conductive material; and
a sacrificial carbon layer consisting of a carbon-based material and a second binder, the sacrificial carbon layer interposed between the current collector and the electrode active material layer,
wherein the sacrificial carbon layer has a thickness of at least 10 μm,
wherein the active material layer has a carbon content of no more than 7 wt %, and
wherein a carbon content of the sacrificial carbon layer is greater than the carbon content of the active material layer.

2. The electrode of claim 1, wherein the carbon-based material is one or more selected from the group consisting of carbon black, graphite, a carbon fiber, amorphous carbon, graphene, and a carbon nanotube.

3. The electrode of claim 2, wherein the carbon material is carbon black.

4. The electrode of claim 1, wherein the first binder and the second binder are the same.

5. The electrode of claim 1, wherein the second binder is polyacrylic acid.

6. The electrode of claim 1, wherein the thickness of the sacrificial carbon layer is at least 15 μm.

7. The electrode of claim 1, wherein the thickness of the sacrificial carbon layer is no more than 30 μm.

8. The electrode of claim 7, wherein the thickness of the sacrificial carbon layer is no more than 20 μm.

9. The electrode of claim 1, wherein a loading amount of the sacrificial carbon layer is within a range 1 mg to 5 mg, per cm² of the current collector.

10. The electrode of claim 9, wherein the loading amount of the sacrificial carbon layer is within a range of 2 mg to 4 mg, per cm² of the current collector.

11. The electrode of claim 9, wherein the loading amount of the sacrificial carbon layer is within the range 2 mg to 3 mg, per cm² of the current collector.

12. The electrode of claim 1, wherein a molar ratio of carbon to oxygen in the oxide active material is within a range of 1:3 to 2:1.

13. The electrode of claim 12, wherein the molar ratio of the carbon to the oxygen in the oxide active material is within a range of 1:2 to 1:1.

14. The electrode of claim 1, wherein the electrode is a cathode.

15. The electrode of claim 14, wherein the active material is a NMC-type active material.

16. An electrochemical cell comprising:
the electrode of claim 1,
a separator, and
a second electrode.

17. A method of manufacturing the electrode of claim 1, comprising:
providing the current collector;
forming the sacrificial carbon layer;
forming a slurry comprising the active material, the first binder, the conductive material, and a solvent;
casting the slurry on the sacrificial carbon layer to form a slurry-coated layer;
drying the slurry to form a dried slurry-coated layer; and
densifying the dried slurry-coated layer to form the active material layer.

18. A method of manufacturing the electrode of claim 17, wherein the forming the sacrificial carbon layer comprises at least one of atomic layer deposition, chemical vapor deposition, electrodeposition, slurry coating, spraying, or dry processing.

19. A method of manufacturing the electrode of claim 17, further comprising forming the sacrificial carbon layer directly on a surface of the current collector.

20. A method of manufacturing the electrode of claim 17, further comprising coating a primer layer onto the current collector and subsequently forming the sacrificial carbon layer on the primer layer.
